(19) United States
(12) Patent Application Publication
(10) Pub. No.: US 2016/0101440 A1
(43) Pub. Date: Apr. 14, 2016

(54) Shell Case Sorter

(71) Applicants: David Justin Grygierczyk, Sacramento, CA (US); Christopher Michael Mugnaini, Sacramento, CA (US); Joshua Villarian Terra, Lodi, CA (US)

(72) Inventors: David Justin Grygierczyk, Sacramento, CA (US); Christopher Michael Mugnaini, Sacramento, CA (US); Joshua Villarian Terra, Lodi, CA (US)

(21) Appl. No.: 14/511,184

(22) Filed: Oct. 10, 2014

(51) Int. Cl. B07B 13/16

(52) U.S. Cl. CPC B07B 13/16

(57) ABSTRACT

The invention provides an adjustable and automated process for sorting shell cases of multiple caliber sizes. The machine consists of a frame with multiple levels of sorting sections. Each sorting section consists of two adjustable sloped spinning rollers driven by electric motors, which increase in separation distance to allow smaller shell case sizes to fall earlier, and larger shell cases to fall later in the process. The shell cases are fed from a hopper to the rollers until sorted into containers. The containers can be adjusted along with the separation distance between rollers to accommodate a range of shell case caliber sizes.

### FIELD OF THE INVENTION

This invention relates to an apparatus and method for sorting spent ammunition or cases according to size.

### BACKGROUND

Reloading has been occurring since the beginning of the use of brass cases. There are many reasons to reload. A common reason is to save money, reloading can save and individual ⅓^{rd} the price of factory ammunition and more in some instances. Another reason would be to create custom ammunition that cannot be bought from a factory so that a firearm can be fine-tuned to shoot at its peak abilities. A small, minute change in the way ammunition is loaded can be the difference between getting a hit or a miss on a target to a match shooter.

Ammunition consists of four main components: (1) The tip is the bullet, (2) the main body is called the case, (3) gun powder or propellant goes inside the case, and (4) the bottom of the case contains the primer. The primer is the component that sets off the chain reaction, ultimately ending with the bullet leaving the barrel of the firearm. Some of the most commonly reloaded types of handgun ammunition are the 9 mm, 0.40, and 0.45 calibers. The caliber refers to the approximate diameter of the bullet. Most calibers are listed in inches. For example, 0.45 would be 45/100 of an inch but occasionally they are listed in millimeters such as the 9 mm. Small arms caliber sizes vary from 0.17 in up to 0.95 in. It is important to note that only centerfire cases can be reloaded. Center-fire refers to the location of the primer within the case. Rimfire ammunition contains a primer compound within the rim of the case. Rimfire ammunition cannot be reloaded because there is not a way to replace the spent primer compound once it has been fired.

After ammunition has been shot, the result is a spent case. The spent cases typically end up on the ground and mixed in with other shooters' empty cases. This is the start of the reloading process. Brass collecting happens after shooting has commenced. All of the mixed calibers need to now be hand separated by caliber. This process has to be done by hand, which is very tedious, time consuming, and often results in errors made by overlooking similarities between calibers.

There is a need for a machine that can quickly and accurately separate mixed brass cases by caliber so that they can be cleaned and reloaded at an efficient rate.

In preparation of this application, prior art was examined to ensure patentability. For example, U.S. Patent Application Publication US2005/0226489 discloses a machine that can sort out projectiles and other objects using a vision system. Another reference, U.S. Patent Application Publication US2003/0057137, is a machine that separates out live ammunition from spent ammunition using jets of air. U.S. patent application Publication Ser. No. 8,074,808 describes a machine that rotates and drops out spent ammunition through slots in the side of a container for a specific sized case. Finally, U.S. patent application Publication Ser. No. 8,297,446 relates to a sorting device that uses vibration to move cases down a track that separates cases into containers.

### SPECIFICATION

The device is used to take spent cases of multiple caliber sizes and separate the cases according to size. The device consists of a frame, cross members, rollers, bearing housings, bearings, motors, sprockets, a control box, a hopper, chutes, and buckets. The frame is constructed of aluminum angle and is welded together so that the entire device is divided into three horizontal sections. The frame has two sides and is connected by round cross members that are also made of aluminum. There is a cross member at each corner of the frame, and at each corner of each section of the frame. The rollers are made of round solid aluminum stock. Each of the three sections has a set of two rollers which are angled down to the next section. The rollers spin inside bearings which are pressed into bearing housings made of aluminum. The bearing housings are mounted to the cross members and allow the rollers to be adjusted laterally at each end. The hopper sits on the top of the device and compromises of sheet aluminum with a slot for the cases to fall through. In between the first and second section, and second and third section, there are chutes made of sheet aluminum that are bent to a shape to allow the cases to be directed properly. The buckets are designed to hang off the side of the frame, into the inside of the device, directly under the rollers. Per each set of rollers, one roller is connected to a 12 volt motor via timing sprockets and a timing belt. The control box is mounted near the top corner of the frame and houses all the electronics, including a power button, a voltage readout, and a dimmer switch.

### BRIEF DESCRIPTION OF THE DRAWINGS

The invention of the present application will now be described in more detail with reference to the accompanying drawings, given only by way of example, in which:

FIG. 1 illustrates a perspective view of a case sorter according to one aspect of the present invention.

FIG. 2 illustrates a more detailed assembly view of the sorting aspect of the present invention.

FIG. 3 illustrates a perspective view of the case holding container of the present invention.

### DETAILED DESCRIPTION

More detailed references will now be made to said components, assemblies, and methods of the present invention, which comprise the best manner of operating the invention presently known to its inventors. The figures are not drawn to scale. The disclosed figures, descriptions, and specific details are merely exemplary of the invention that may be embodied in diverse and alternative variations. Therefore, the disclosed figures, descriptions, and specific details are not to be interpreted as limiting, but merely represent aspects of the invention and/or a representative basis for teaching to employ the present invention with the inventor's consent.

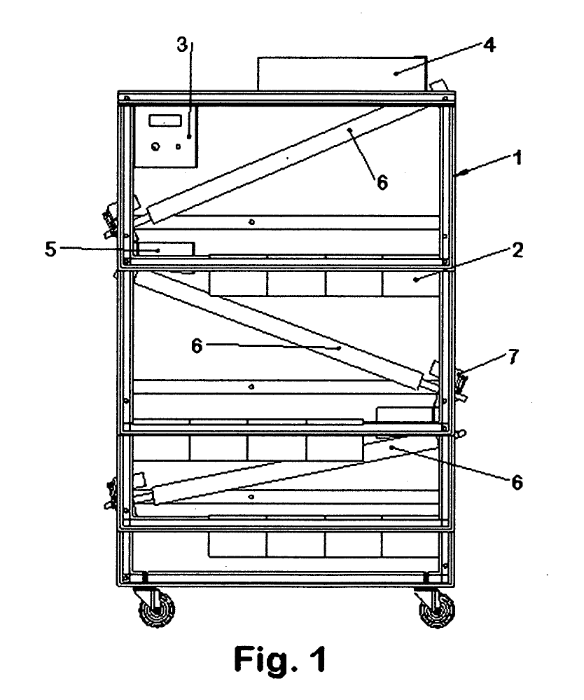

FIG. 1 illustrates a case sorter according to an aspect of the present invention. Said case sorter sorts cases by initially moving cases from a container or hopper 4 onto two adjacent spinning rollers 6. Said rollers 6 serve as the actual sorting mechanism. Once the distance between the rollers becomes larger than the diameter of the case, the case will drop down into its respective bucket 2. If the case does not fall while on the first level, it will drop off the end of the rollers 6, onto the transfer chute 5, and back onto the next set of rollers 6. The same process will occur if the case does not fall while on the second level. Said rollers are turned by at least one twelve volt motor 7 on each of the three levels. The electronics and controls for said motors are housed in a box 3 near the top of the entire sorting device. All of the parts are mounted to the frame 1.

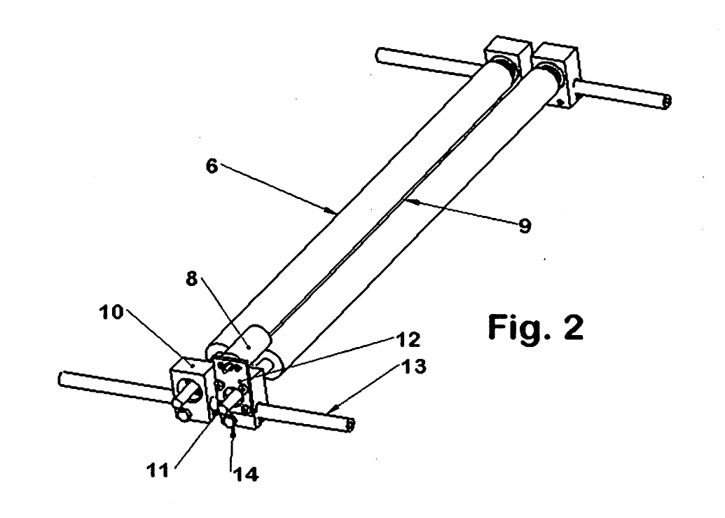

FIG. 2 illustrates a portion of the case sorter to an aspect of the present invention. Said rollers 6 are mounted on self-aligning bearings that are press fitted inside a bearing housing 10. Said bearing housings 10 are mounted onto cross members 13 and can be adjusted to be on any point on said cross members 13. A screw 14 can be tightened once the correct position of said bearing housings 10 is found. Also, another screw 11 can be adjusted to aid in spacing adjacent bearing housing 10. Said twelve volt motors 8 are mounted onto said bearing housings 10 by way of a flat motor mount 12. One end of each said roller 6 is connected to said motor 8 by timing sprockets and a timing belt (not shown). The adjacent roller 6 is connected to the powered roller 6 by an o-ring (not shown). The space 9 between adjacent rollers increases gradually because said rollers 6 are not perfectly parallel.

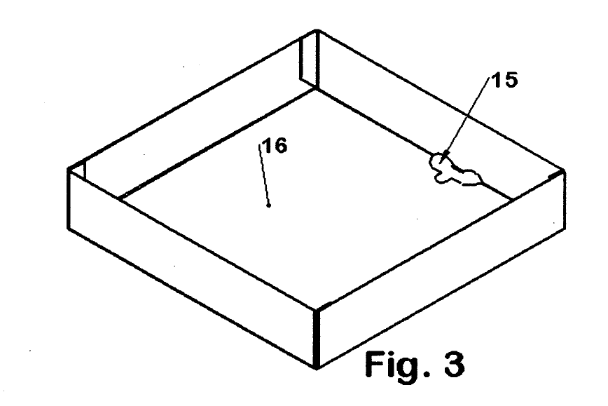

FIG. 3 illustrates a hopper for the case sorter according to an aspect of the present invention. Sheet aluminum 16 is bent to the correct size and a slot 15 is cut to allow cases to fall through and onto said rollers 6.

1. An apparatus and method for sorting ammunition cases by size comprising of a frame, an ammunition staging container, with at least one set of side by side rollers, said rollers adjustable at both ends, said rollers are supported at both ends by adjustable bearing housings, said rollers have an adjustable gap that begin narrow and become wider throughout the sorting process, where desired cases fall through at desired locations into perspective containers which are supported by the frame, said bearing housings are mounted to said frame using support cross members, said bearing housings support motors with mounting assembly, said motors are connected to said rollers using a belt drive system, said motors are connected to an electrical box that powers said apparatus, said motors turn said rollers in opposite directions, cases that do not fall through said gap are guided to the next set of said rollers using chutes, cases that do not fall through any said gaps end up in a final container, said chutes are supported by cross members on said frame, and said frame is supported by wheels.

2. The apparatus according to claim 1 wherein said gap between said rollers are spaced between 0.16 to 0.60 inches.

3. The apparatus according to claim 1 wherein said ammunition staging container is comprised of sheet aluminum.

4. The apparatus according to claim 3 wherein said ammunition staging container has an opening wide enough for the largest diameter case to pass through so the staged cases can transition to the next stage of the sorting process.

5. The apparatus according to claim 1 wherein said rollers are round.

6. The apparatus according to claim 5 wherein said rollers are angled from a higher part of said frame to a lower part of said frame to allow the movement of cases through the sorting process assisted by gravity.

7. The apparatus according to claim 5 wherein said rollers are supported by said bearing housings.

8. The apparatus according to claim 5 wherein said rollers are connected to said motors at the end of said rollers using said belt drive system, where said motors and said belt drive systems rotate said rollers in opposite directions to aid in the movement of cases through the sorting process.

9. The apparatus according to claim 1 wherein said bearing housing is made of aluminum.

10. The apparatus according to claim 9 wherein said bearing housing contains said bearings which are self-aligning such that said gap between said rollers is possible.

11. The apparatus according to claim 9 wherein said bearing housing is mounted to said cross members consisting of a pinch bolt to be tightened such that said bearing housings will not move after being set to generate said desired gap between said rollers.

12. The apparatus according to claim 9 wherein said bearing housings can be adjusted with the turning of a bolt, therefore increasing or decreasing the distance between said bearing housings and increasing or decreasing the distance between said rollers (claim 5).

13. The apparatus according to claim 1 wherein said frame is made of angled metal.

14. The apparatus according to claim 13 wherein said frame supports said containers in such a way that said containers hang under said rollers such that cases that fall through said gap between said rolls fall into said containers.
